(19) United States
(12) Patent Application Publication
(10) Pub. No.: US 2014/0112026 A1
(43) Pub. Date: Apr. 24, 2014

(54) RESONANT DC CONVERTER

(71) Applicant: NATIONAL TSING HUA UNIVERSITY, Hsinchu City (TW)

(72) Inventors: Ching-Tsai Pan, Hsinchu City (TW); Po-Yen Chen, Taipei (TW); Ming-Chieh Cheng, Taipei (TW); Ching-Hsiang Cheng, Chiayi City (TW)

(73) Assignee: NATIONAL TSING HUA UNIVERSITY, Hsinchu City (TW)

(21) Appl. No.: 13/684,779

(22) Filed: Nov. 26, 2012

(30) Foreign Application Priority Data
Oct. 24, 2012 (TW) 101139382

(51) Int. Cl. H02M 3/335; H02M 3/07

(52) U.S. Cl. CPC H02M 3/33569; H02M 3/07
USPC 363/21.02; 363/61

(57) ABSTRACT

A resonant DC converter, combines a voltage type auto charge pump circuit with a full-bridge or half-bridge resonant DC conversion circuit at a primary side of a transformer, combines a double-voltage rectifier circuit at a secondary side of the transformer, and grants the circuit of the invention with characteristics of variable circuit architecture by means of the design of circuit parameters and the action of the LC resonant circuit. Integration of switching elements of the converter circuit and the use of characteristics of automatically changing the circuit architecture contribute to reduce the switching losses and increase the circuit conversion efficiency. Low output voltage ripple enables the circuit of the invention to avoid using large-capacitance electrolytic capacitors and be able to extend the service life of the transformer. The operation of the circuit of the invention at boost or buck mode can be controlled by adjusting the circuit parameters.

### BACKGROUND OF THE INVENTION

1. Field of the Invention

The present invention relates to a resonant DC converter which has an integrated soft-switching technology with high voltage conversion. More particularly, the present invention relates to a resonant DC converter which integrates a transformer, combines a voltage type auto charge pump circuit with a full-bridge or half-bridge resonant DC conversion circuit at a primary side of the transformer, grants the circuit of the invention with characteristics of variable circuit architecture while achieving the effect of soft switching by the design of circuit parameters and the action of the LC resonant circuit, and controls the operation of the circuit at boost or buck mode by adjusting the circuit parameters.

2. Description of Related Art

In general, a conventional half-bridge resonant DC converter is usually used in step-down applications. As shown in FIG. 9, a half-bridge resonant DC converter circuit is mainly driven by two active switches in a complementary manner with 50% duty cycle. A blind time area is introduced to a turning state interval between two switching elements, while a zero voltage switching mechanism is completed in this interval. A resonant circuit is constituted by an inductor L1, a capacitor C1, magnetized inductance Lm of a transformer, and a load reflected by a secondary side of the transformer. The capacitor C1 is responsible for blocking a DC current and any resonant effect, and generates a higher resonant frequency along with the inductor L1, while produces a lower resonant frequency along with the inductor L1 and the magnetized inductance Lm.

A currently available half-bridge resonant DC converter usually achieves the purpose of reducing the cost of components and the volume of the converter by means of increasing the switching frequency to cut down the capacitance value and a magnetic element's volume in order to increase the power density of the DC converter. However, while enhancing the switching frequency of the conversion circuit, switching loss of switching elements increases accordingly. Problems such as electric magnetic interruption (EMI) occur as well. Therefore, the conventional converter circuit cannot meet the need for users in actual use any more.

### SUMMARY OF THE INVENTION

A main purpose of this invention is to overcome the shortcomings of conventional technology, and provide a resonant DC converter which has an integrated soft-switching technology with high voltage conversion. The converter of this invention integrates a transformer, and combines a voltage type auto charge pump circuit with a full-bridge or half-bridge resonant DC conversion circuit at a primary side of the transformer. The design of circuit parameters and the action of the LC resonant circuit make the circuit have the characteristics of variable circuit architecture, and achieve the effect of soft switching. The operation of the circuit of the invention at boost or buck mode can be controlled by adjusting the circuit parameters.

It is another purpose of this invention to provide a resonant DC converter which combines a double-voltage rectifier circuit at a secondary side of a transformer to further enhance the output voltage conversion ratio and reduce the output voltage ripple, and further integrate the switching elements of the converter circuit with the use characteristics of automatically changing the circuit architecture so as to reduce the switching losses and increase circuit conversion efficiency of the converter circuit.

It is still purpose of the invention to provide a resonant DC converter having low output voltage ripple and able to avoid using large-capacitance electrolytic capacitors and to extend the service life of the transformer, so as to achieve high power density, high voltage conversion ratio, low costs, low electric magnetic interruption (EMI), low output voltage ripple, long service life and high conversion efficiency.

In order to achieve the above and other objectives, a half-bridge resonant DC converter of the invention is used to convert a DC input voltage into a DC output voltage in order to provide a load with power supply. In one embodiment of the invention, the resonant DC converter includes:
a front-end conversion circuit, comprising a half-bridge resonant DC conversion circuit and a voltage-type auto charge pump circuit, wherein the half-bridge resonant conversion circuit is provided with a positive voltage terminal and a negative voltage terminal at an input side respectively connecting a first active switching element and a second active switching element to a positive voltage terminal of a first inductor, the positive voltage terminal of the first inductor is coupled to one common node between the first active switching element and the second active switching element, a negative voltage terminal of the first inductor; is coupled in series to a semi-resonant circuit of the voltage-type auto charge pump circuit, the semi-resonant circuit contains a second inductor and a first capacitor coupled with the second inductor in parallel, and the voltage-type auto charge pump circuit further includes a second capacitor coupled in series to the semi-resonant circuit; and
a transformer, wherein a primary side of the transformer is coupled to the front-end conversion circuit and to the second capacitor in parallel, a secondary side of the transformer is coupled to a rear-end conversion circuit which is electrically coupled with the front-end conversion circuit through the transformer.

In one embodiment, the secondary side of the transformer is coupled with the rear-end conversion circuit which is a full-bridge rectifier circuit constituted by four diodes and a capacitor.

In one embodiment, the secondary side of the transformer is coupled with the rear-end conversion circuit which is a double-voltage rectifier circuit constituted by two diodes and two capacitors.

In one embodiment, the transformer is a multi-winding transformer, and the secondary side of the transformer is coupled with the rear-end conversion circuit which is a rectifier circuit constituted by two diodes and one capacitor.

In one embodiment, the transformer is a multi-winding transformer, and the secondary side of the transformer is coupled with the rear-end conversion circuit which is a triple-voltage rectifier circuit constituted by four diodes and three capacitors.

In one embodiment, the transformer is a multi-winding transformer, and the secondary side of the transformer is coupled with the rear-end conversion circuit which is a four times-voltage rectifier circuit constituted by four diodes and four capacitors.

In one embodiment, the transformer is a multi-winding transformer, and the secondary side of the transformer is coupled with the rear-end conversion circuit which is a five times-voltage rectifier circuit constituted by six diodes and five capacitors.

In one embodiment, the transformer is a multi-winding transformer, and the secondary side of the transformer is coupled with the rear-end conversion circuit which is a six times-voltage rectifier circuit constituted by six diodes and six capacitors.

In one embodiment, a full-bridge resonant DC converter, used to convert a DC input voltage into a DC output voltage in order to provide a load with power supply. The full-bridge resonant DC converter includes:
a front-end conversion circuit, including a full-bridge resonant DC conversion circuit and a voltage-type auto charge pump circuit, wherein the full-bridge resonant conversion circuit is provided with a positive voltage terminal at an input side in coupling with a first active switching element and a second active switching element in parallel, and a negative voltage terminal at the input side in coupling with a third active switching element and a fourth active switching element in parallel, the first active switching element and the third active switching element are coupled in series with a positive voltage terminal of a first inductor, the positive voltage terminal of the first inductor is coupled with one common node between the first active switching element and the third active switching element, a negative voltage terminal of the first inductor is coupled in series to a semi-resonant circuit of the voltage-type auto charge pump circuit, the semi-resonant circuit contains a second inductor and a capacitor coupled with the second inductor in parallel, the voltage-type auto charge pump circuit further includes a second capacitor coupled in series with the semi-resonant circuit, and the second capacitor is coupled with one common node between the second active switching element and the fourth active switching element; and
a transformer, wherein a primary side of the transformer is coupled to the front-end conversion circuit and to the second capacitor in parallel, a secondary side of the transformer is coupled to a rear-end conversion circuit which is electrically coupled with the front-end conversion circuit through the transformer.

In one embodiment, the secondary side of the transformer is coupled with the rear-end conversion circuit which is a full-bridge rectifier circuit constituted by four diodes and a capacitor.

In one embodiment, the secondary side of the transformer is coupled with the rear-end conversion circuit which is a double-voltage rectifier circuit constituted by two diodes and two capacitors.

In one embodiment, the transformer is a multi-winding transformer, and the secondary side of the transformer is coupled with the rear-end conversion circuit which is a rectifier circuit constituted by two diodes and one capacitor.

In one embodiment, the transformer is a multi-winding transformer, and the secondary side of the transformer is coupled with the rear-end conversion circuit which is a triple-voltage rectifier circuit constituted by four diodes and three capacitors.

In one embodiment, the transformer is a multi-winding transformer, and the secondary side of the transformer is coupled with the rear-end conversion circuit which is a four times-voltage rectifier circuit constituted by four diodes and four capacitors.

In one embodiment, the transformer is a multi-winding transformer, and the secondary side of the transformer is coupled with the rear-end conversion circuit which is a five times-voltage rectifier circuit constituted by six diodes and five capacitors.

In one embodiment, the transformer is a multi-winding transformer, and the secondary side of the transformer is coupled with the rear-end conversion circuit which is a six times-voltage rectifier circuit constituted by six diodes and six capacitor.

### BRIEF DESCRIPTION OF THE DRAWINGS

FIG. 1 A is a schematic diagram of a full-bridge rectifier circuit at a secondary side of a transformer of a half-bridge resonant DC converter circuit according to the invention.

FIG. 1B is a schematic diagram of a double-voltage rectifier circuit at a secondary side of a transformer of a half-bridge resonant DC converter circuit according to the invention.

FIG. 1C is a schematic diagram of a rectifier circuit at a secondary side of a transformer of a half-bridge resonant DC converter circuit according to the invention.

FIG. 1D is a schematic diagram of a triple-voltage rectifier circuit at a secondary side of a transformer of a half-bridge resonant DC converter circuit according to the invention.

FIG. 1E is a schematic diagram of a four times-voltage rectifier circuit at a secondary side of a transformer of a half-bridge resonant DC converter circuit.

FIG. 1F is a schematic diagram of a five times-voltage rectifier circuit at a secondary side of a transformer of a half-bridge resonant DC converter circuit according to the invention.

FIG. 1G is a schematic diagram of a six times-voltage rectifier circuit at a secondary side of a transformer of a half-bridge resonant DC converter circuit according to the invention.

FIG. 2 A is a schematic diagram of a full-bridge rectifier circuit at a secondary side of a transformer of a full-bridge resonant DC converter circuit according to the invention.

FIG. 2B is a schematic diagram of a double-voltage rectifier circuit at a secondary side of a transformer of a full-bridge resonant DC converter circuit according to the invention.

FIG. 2C is a schematic diagram of a rectifier circuit at a secondary side of a transformer of a full-bridge resonant DC converter circuit according to the invention.

FIG. 2D is a schematic diagram of a triple-voltage rectifier circuit at a secondary side of a transformer of a full-bridge resonant DC converter circuit according to the invention.

FIG. 2E is a schematic diagram of a four times-voltage rectifier circuit at a secondary side of a transformer of a full-bridge resonant DC converter circuit according to the invention.

FIG. 2F a schematic diagram of a five times-voltage rectifier circuit at a secondary side of a transformer of a full-bridge resonant DC converter circuit according to the invention.

FIG. 2G is a schematic diagram of a six times-voltage rectifier circuit at a secondary side of a transformer of a full-bridge resonant DC converter circuit according to the invention.

FIG. 3 is a schematic diagram of an equivalent circuit of a resonant DC converter in the Working Mode 1 according to the present invention.

FIG. 4 is a schematic diagram of an equivalent circuit of a resonant DC converter in the Working Mode 2 according to the present invention.

FIG. 5 is a schematic diagram of an equivalent circuit of a resonant DC converter in the Working Mode 3 according to the present invention.

FIG. 6 is a schematic diagram of an equivalent circuit of a resonant DC converter in the Working Mode 4 according to the present invention.

FIG. 7 is a schematic diagram of a simulated waveform 1 for V_{C1}, V_{C2}, V_{O}, I_{M1}, I_{M2}, PWM1 and PWM2 signals of a resonant DC converter according to the present invention.

FIG. 8 is a schematic diagram of a simulated waveform 2 for V_{C1}, V_{C2}, V_{O}, I_{M1}, I_{M2}, PWM1 and PWM2 signals of a resonant DC converter according to the invention.

FIG. 9 is a schematic diagram of a conventional half-bridge resonant DC converter circuit.

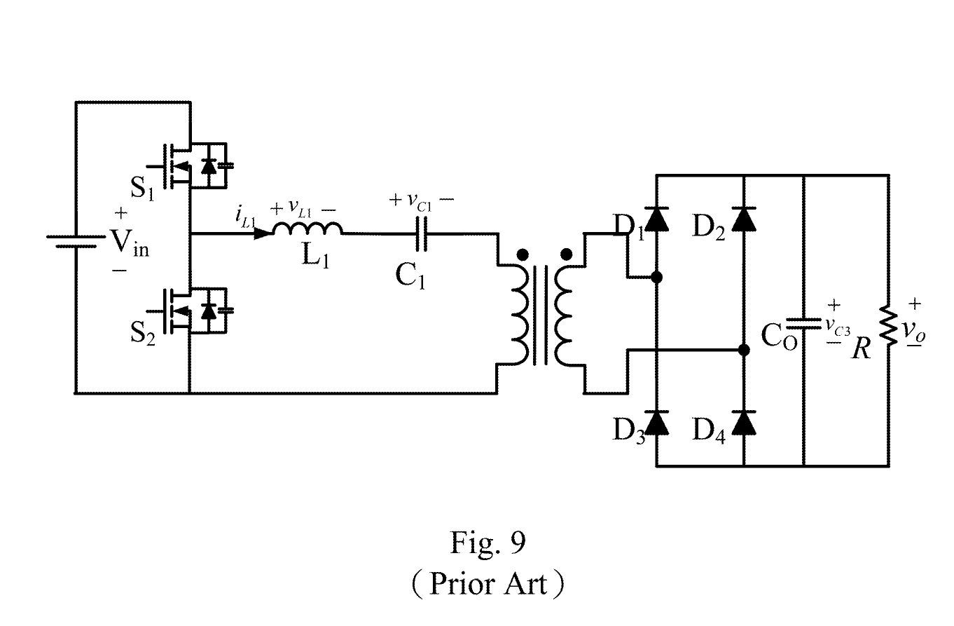

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

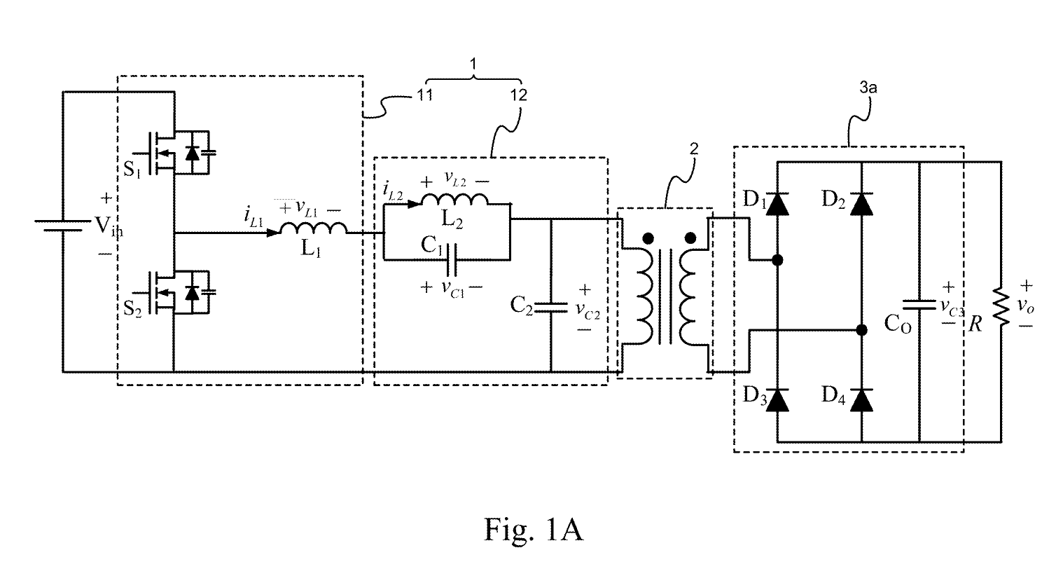

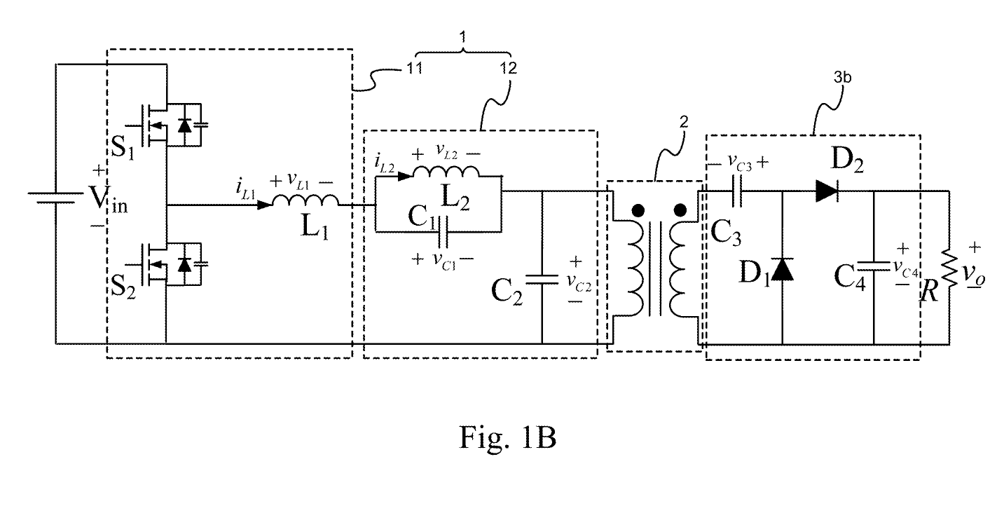

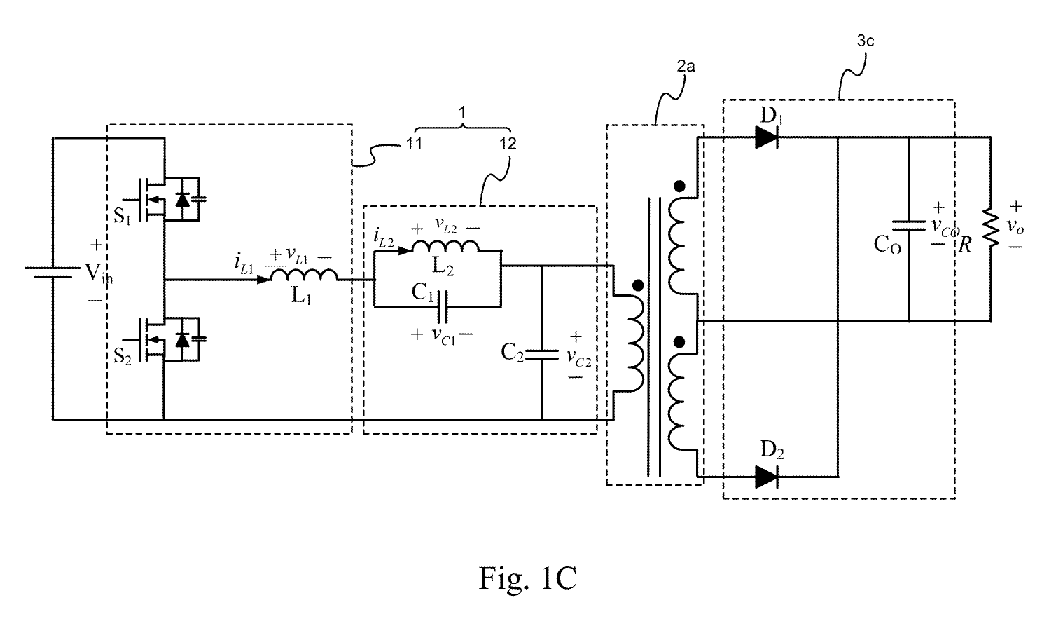

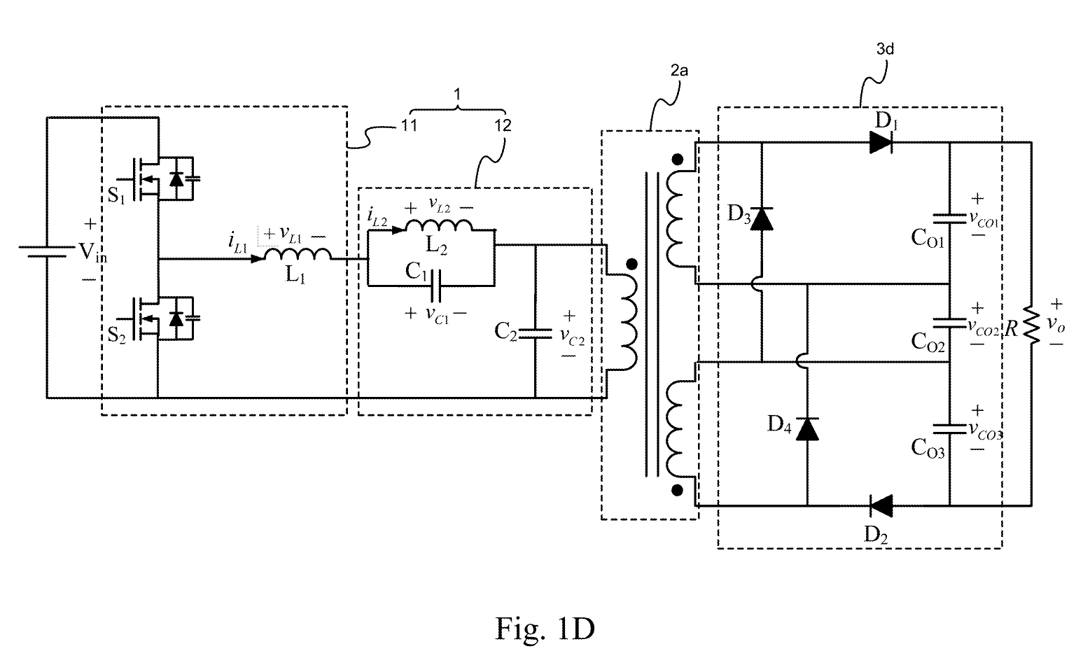

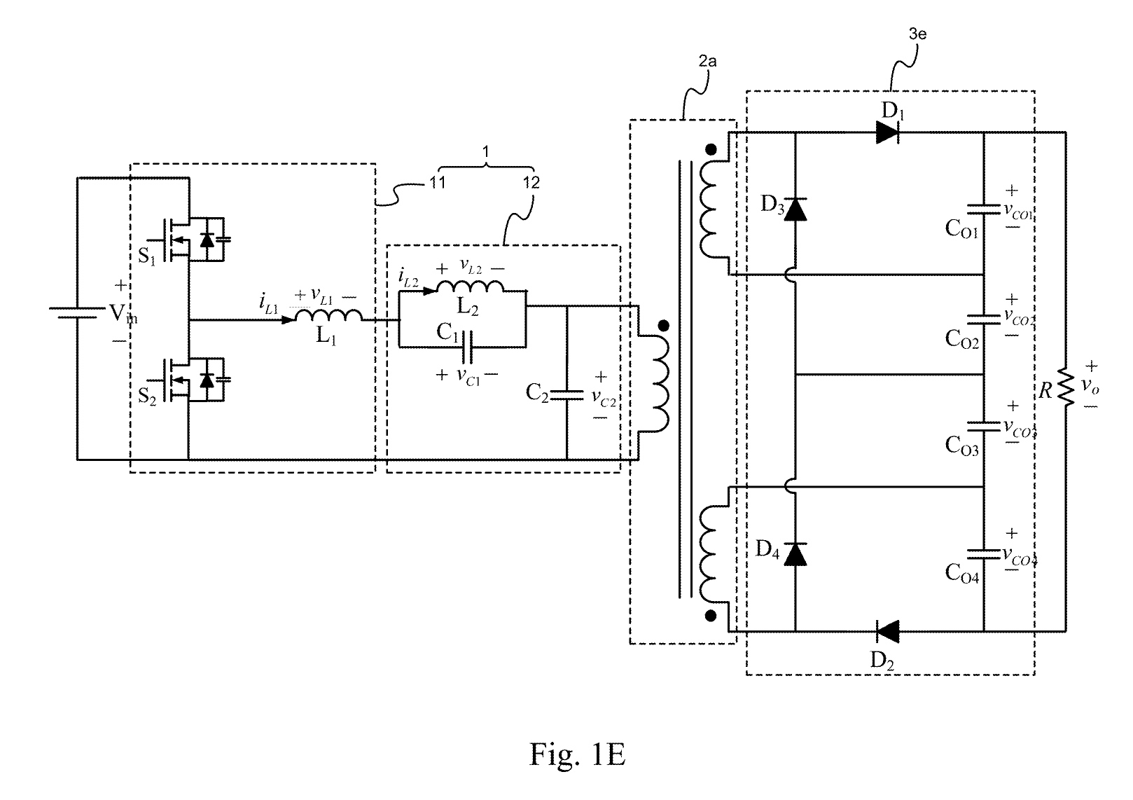

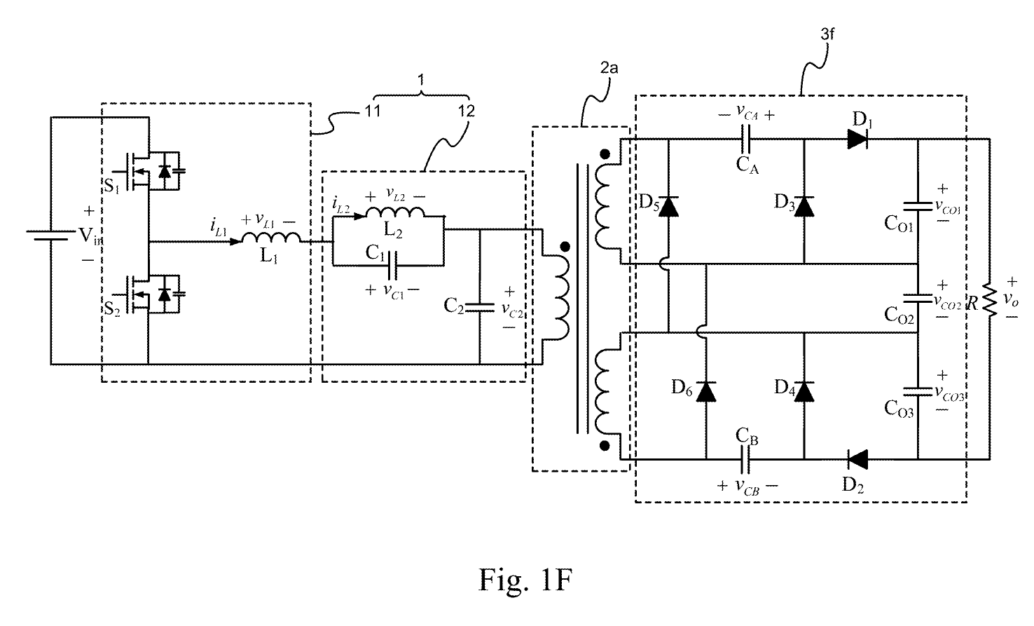

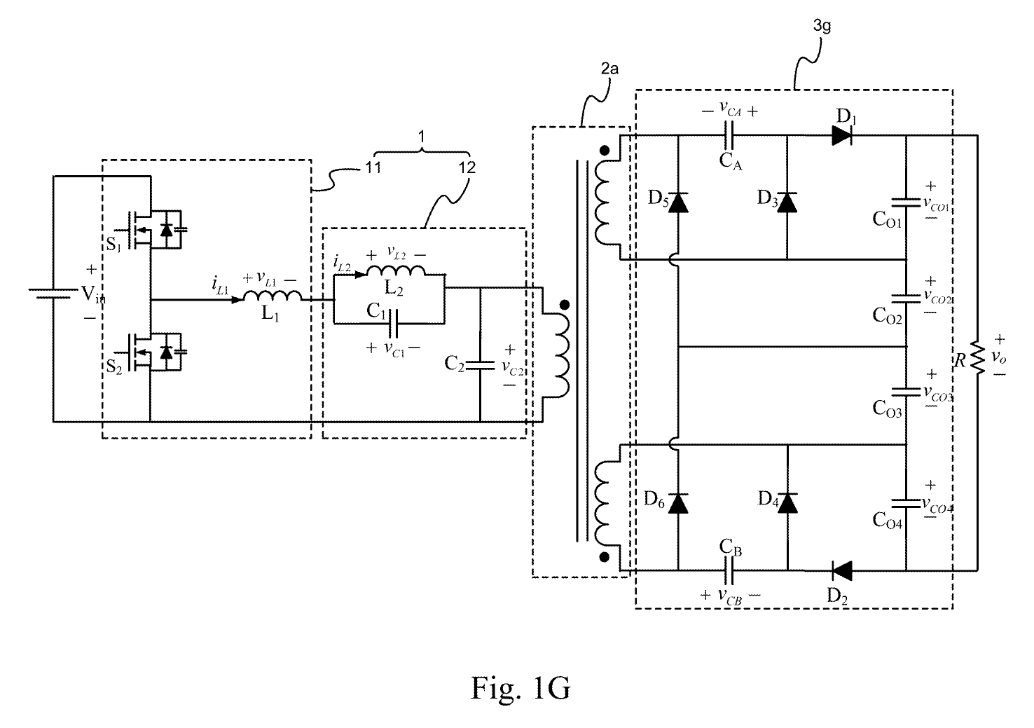

FIG. 1 A through FIG. 1G are respectively a schematic diagram of a full-bridge rectifier circuit at a secondary side of a transformer of a half-bridge resonant DC converter circuit, a schematic diagram of a double-voltage rectifier circuit at a secondary side of a transformer of a half-bridge resonant DC converter circuit, a schematic diagram of a rectifier circuit at a secondary side of a transformer of a half-bridge resonant DC converter circuit, a schematic diagram of a triple-voltage rectifier circuit at a secondary side of a transformer of a half-bridge resonant DC converter circuit, a schematic diagram of a four times-voltage rectifier circuit at a secondary side of a transformer of a half-bridge resonant DC converter circuit, a schematic diagram of a five times-voltage rectifier circuit at a secondary side of a transformer of a half-bridge resonant DC converter circuit, and a schematic diagram of a six times-voltage rectifier circuit at a secondary side of a transformer of a half-bridge resonant DC converter circuit, according to one embodiment of the invention. As shown, the half-bridge resonant DC converter circuit according to the invention is used to convert a DC input voltage into a DC output voltage to provide a load with power supply, and includes at least a front-end conversion circuit 1 and a transformer 2 or 2a.

The front-end conversion circuit 1 includes a half-bridge resonant DC conversion circuit 11 and a voltage-type auto charge pump circuit 12. The half-bridge resonant conversion circuit 11 is provided with a positive voltage terminal and a negative voltage terminal at an input side respectively coupling a first active switching element S1 and a second active switching element S2 to a positive voltage terminal of a first inductor L1. The positive voltage terminal of the first inductor L1 is coupled to one common node between the first active switching element S1 and the second active switching element S2. A negative voltage terminal of the first inductor L1 is coupled in series to a semi-resonant circuit of the voltage-type auto charge pump circuit 12. The semi-resonant circuit contains a second inductor L2 and a capacitor C1 coupled with the second inductor L2 in parallel. The voltage-type auto charge pump circuit further includes a second capacitor C2 coupled in series to the semi-resonant circuit.

A primary side of the transformer 2 or 2a is coupled to the front-end conversion circuit 1, and is coupled with the second capacitor C2 in parallel. A secondary side of the transformer 2 or 2a is coupled to a rear-end conversion circuit which is electrically coupled with the front-end conversion circuit 1 through the transformer 2 or 2a. In this way, a new half-bridge resonant DC converter is accomplished.

The secondary side of the above transformer 2 is coupled with the rear-end conversion circuit which is a full-bridge rectifier circuit 3a constituted by four diodes D₁, D₂, D₃, D₄ and a capacitor C₀, as shown in FIG. 1A.

The secondary side of the above transformer 2 is coupled with the rear-end conversion circuit which is a double-voltage rectifier circuit 3b constituted by two diodes D₁, D₂ and two capacitors C₃, C₄, as shown in FIG. 1B.

The above transformer is a multi-winding transformer 2a and the secondary side thereof is coupled with the rear-end conversion circuit which is a rectifier circuit 3c constituted by two diodes D₁, D₂ and a capacitor C₀, as shown in FIG. 1C.

The above transformer is a multi-winding transformer 2a and the secondary side thereof is coupled with the rear-end conversion circuit which is a triple-voltage rectifier circuit 3d constituted by four diodes D₁, D₂, D₃, D₄ and three capacitors C₀₁, C₀₂, C₀₃, as shown in FIG. 1D.

The above transformer is a multi-winding transformer 2a and the secondary side thereof is coupled with the rear-end conversion circuit which is a four times-voltage rectifier circuit 3e constituted by four diodes D₁, D₂, D₃, D₄ and four capacitors C₀₁, C₀₂, C₀₃, C₀₄, as shown in FIG. 1E.

The above transformer is a multi-winding transformer 2a and the secondary side thereof is coupled with the rear-end conversion circuit which is a five times-voltage rectifier circuit 3f constituted by six diodes D₁, D₂, D₃, D₄, D₅, D₆ and five capacitors C_{A}, C₀₁, C₀₂, C₀₃, C_{B}, as shown in FIG. 1F.

The above transformer is a multi-winding transformer 2a and the secondary side thereof is coupled with the rear-end conversion circuit which is a six times-voltage rectifier circuit 3g constituted by six diodes D₁, D₂, D₃, D₄, D₅, D₆ and six capacitors C_{A}, C₀₁, C₀₂, C₀₃, C₀₄, C_{B}, as shown in FIG. 1G.

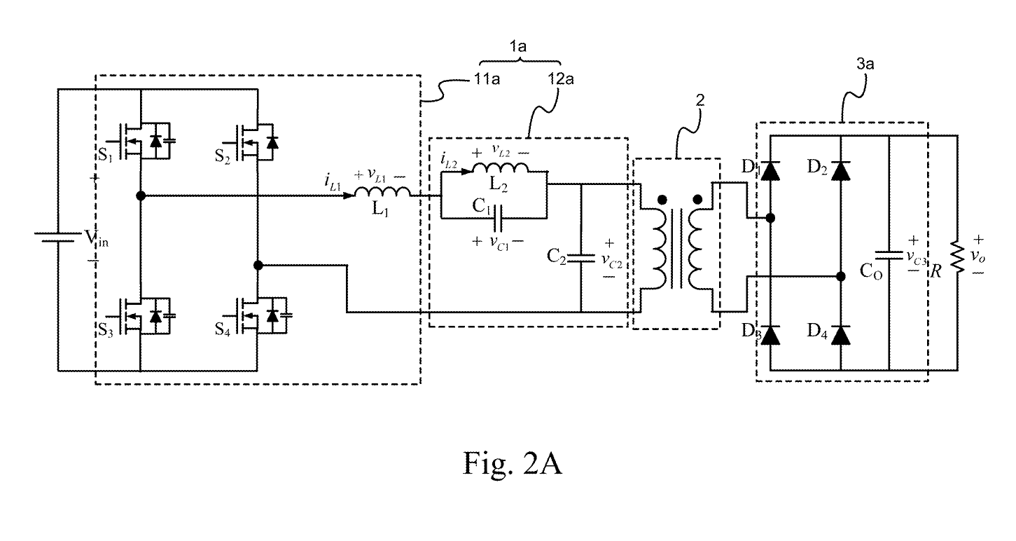

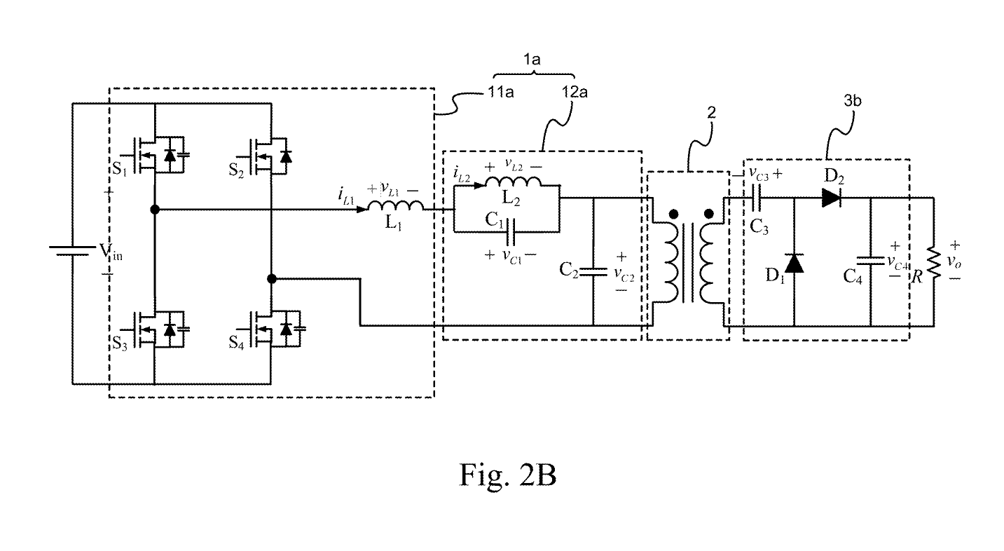

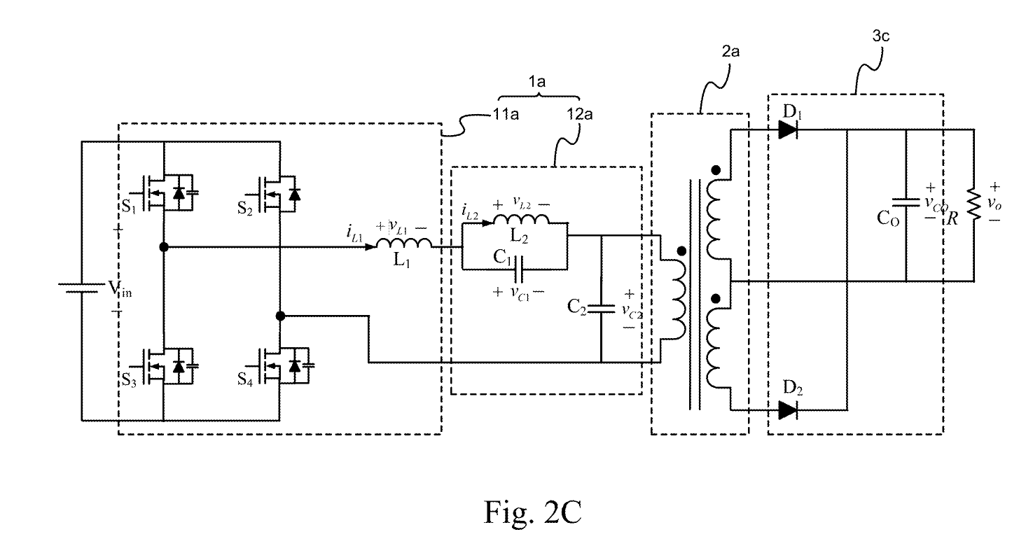

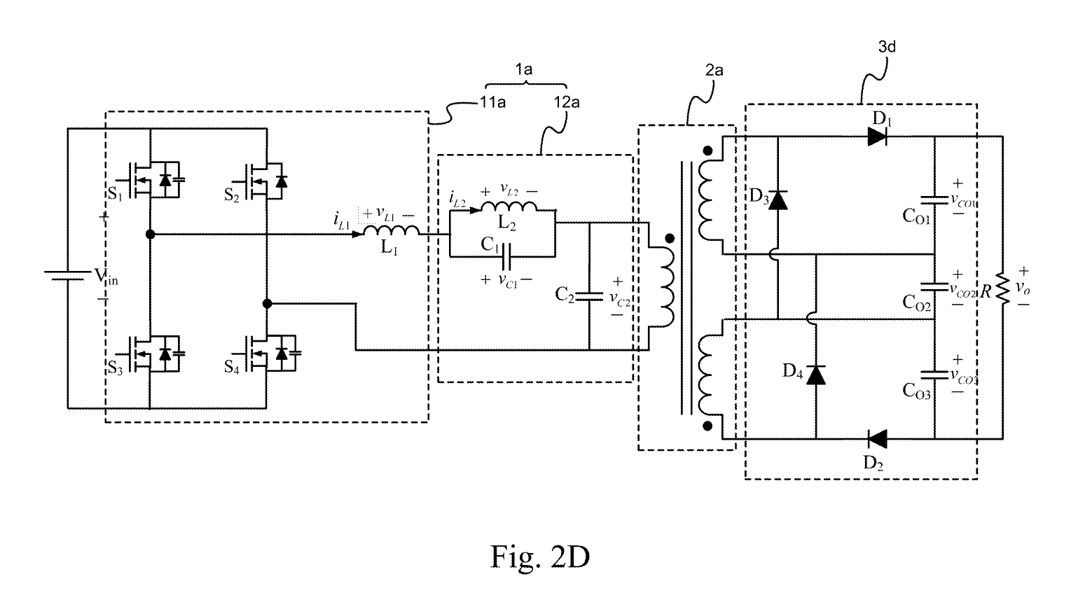

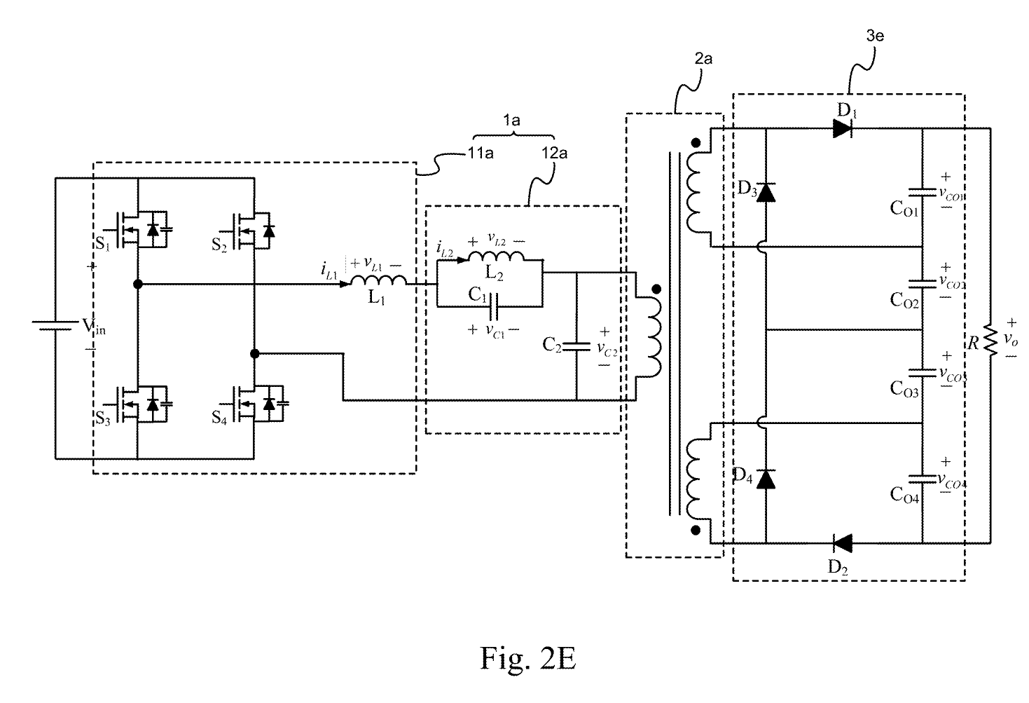

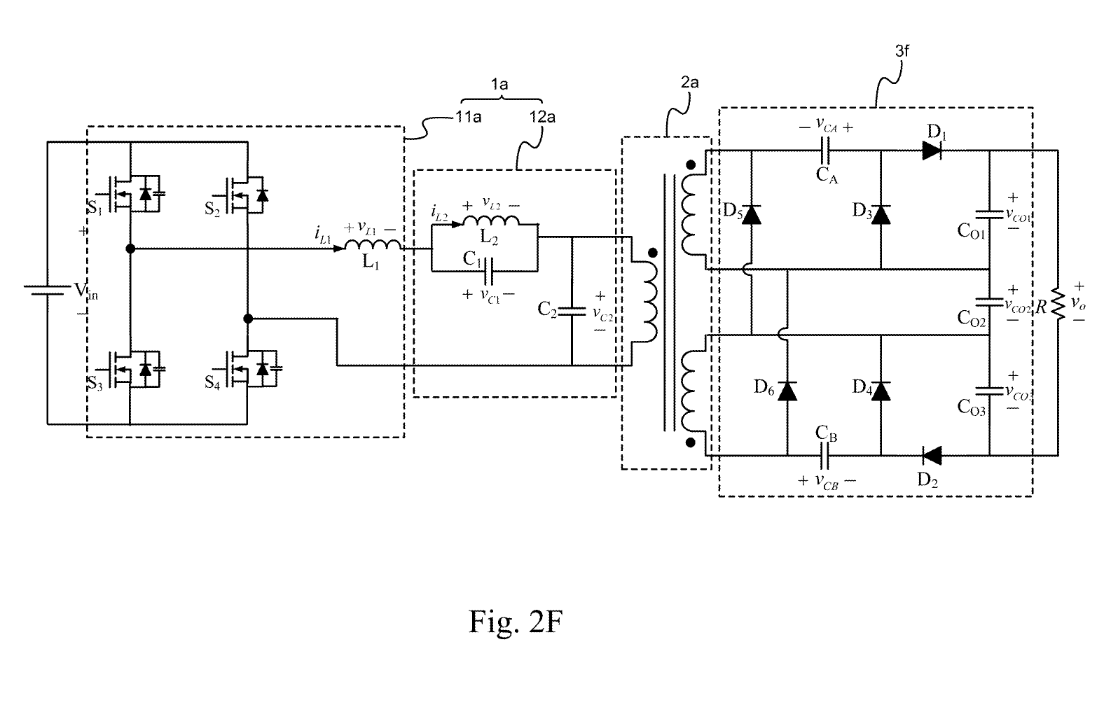

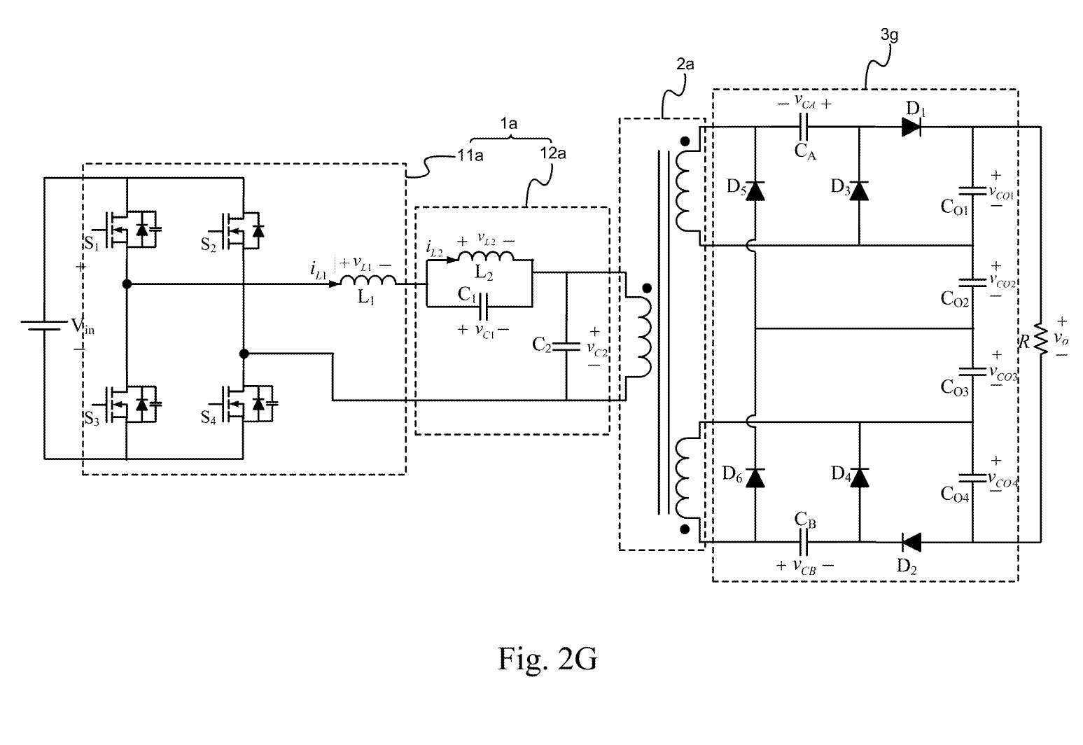

FIG. 2A through FIG. 2G are respectively a schematic diagram of a full-bridge rectifier circuit at a secondary side of a transformer of a full-bridge resonant DC converter circuit, a schematic diagram of a double-voltage rectifier circuit at a secondary side of a transformer of a full-bridge resonant DC converter circuit, a schematic diagram of a rectifier circuit at a secondary side of a transformer of a full-bridge resonant DC converter circuit, a schematic diagram of a triple-voltage rectifier circuit at a secondary side of a transformer of a full-bridge resonant DC converter circuit, a schematic diagram of a four times-voltage rectifier circuit at a secondary side of a transformer of a full-bridge resonant DC converter circuit, a schematic diagram of a five times-voltage rectifier circuit at a secondary side of a transformer of a full-bridge resonant DC converter circuit, and a schematic diagram of a six times-voltage rectifier circuit at a secondary side of a transformer of a full-bridge resonant DC converter circuit, according to one embodiment of the invention. As shown, the full-bridge resonant DC converter circuit according to the invention is used to convert a DC input voltage into a DC output voltage to provide a load with power supply, and includes at least a front-end conversion circuit 1a and a transformer 2 or 2a.

The front-end conversion circuit 1a includes a full-bridge resonant DC conversion circuit 11a and a voltage-type auto charge pump circuit 12a. The full-bridge resonant conversion circuit 11 is provided with a positive voltage terminal at an input side in coupling with a first active switching element S1 and a second active switching element S2 in parallel, and a negative voltage terminal at the input side in coupling with a third active switching element S3 and a fourth active switching element S4 in parallel. The first active switching element S1 and the third active switching element S3 are coupled in series with a positive voltage terminal of a first inductor L1. The positive voltage terminal of the first inductor L1 is coupled with one common node between the first active switching element S1 and the third active switching element S3. A negative voltage terminal of the first inductor L1 is coupled in series to a semi-resonant circuit of the voltage-type auto charge pump circuit 12a. The semi-resonant circuit contains a second inductor L2 and a capacitor C1 coupled with the second inductor L2 in parallel. The voltage-type auto charge pump circuit further includes a second capacitor C2 coupled in series with the semi-resonant circuit. The second capacitor C2 is coupled with one common node between the second active switching element S2 and the fourth active switching element S4.

The primary side of the transformer 2 or 2a is coupled to the front-end conversion circuit 1a, and is coupled with the second capacitor C2 in parallel. The secondary side of the transformer 2 or 2a is coupled to a rear-end conversion circuit which is electrically coupled with the front-end conversion circuit 1a through the transformer 2 or 2a. In this way, a new full-bridge resonant DC converter is accomplished.

The secondary side of the above transformer 2 is coupled with the rear-end conversion circuit which is a full-bridge rectifier circuit 3a constituted by four diodes D₁, D₂, D₃, D₄ and a capacitor C₀, as shown in FIG. 2A.

The secondary side of the above transformer 2 is coupled with the rear-end conversion circuit which is a double-voltage rectifier circuit 3b constituted by two diodes D₁, D₂, and two capacitors C₃, C₄, as shown in FIG. 2B.

The above transformer is a multi-winding transformer 2a and the secondary side thereof is coupled with the rear-end conversion circuit which is a rectifier circuit 3c constituted by two diodes D₁, D₂ and a capacitor C₀, as shown in FIG. 2C.

The above transformer is a multi-winding transformer 2a and the secondary side thereof is coupled with the rear-end conversion circuit which is a triple-voltage rectifier circuit 3d constituted by four diodes D₁, D₂, D₃, D₄ and three capacitors C₀₁, C₀₂, C₀₃, as shown in FIG. 2D.

The above transformer is a multi-winding transformer 2a and the secondary side thereof is coupled with the rear-end conversion circuit which is a four times-voltage rectifier circuit 3e constituted by four diodes D₁, D₂, D₃, D₄ and four capacitors C₀₁, C₀₂, C₀₃, C₀₄, as shown in FIG. 2E.

The above transformer is a multi-winding transformer 2a and the secondary side thereof is coupled with the rear-end conversion circuit which is a five times-voltage rectifier circuit 3f constituted by six diodes D₁, D₂, D₃, D₄, D₅, D₆ and five capacitors C_{A}, C₀₁, C₀₂, C₀₃, C_{B}, as shown in FIG. 2F.

The above transformer is a multi-winding transformer 2a and the secondary side thereof is coupled with the rear-end conversion circuit which is a six times-voltage rectifier circuit 3g constituted by six diodes D₁, D₂, D₃, D₄, D₅, D₆ and six capacitors C_{A}, C₀₁, C₀₂, C₀₃, C₀₄, C_{B}, as shown in FIG. 2G.

In the embodiment of the invention which is exemplified by the half-bridge resonant DC converter circuit with the reference to FIG. 1B, the circuit of the invention is based on four capacitors, two inductors, two diodes and one transformer. When the input terminal is of the half-bridge circuit architecture, the circuit works at the operation principle as follows. The first inductor L1 is used to suppress a swell current. Then, the second inductor L2 is coupled with the first capacitor C1 in parallel to constitute a semi-resonant circuit which is then coupled with the second capacitor C2 to constitute an in-series resonance in-parallel load circuit in order to achieve the effect of high voltage conversion ratio. When the capacitance value of the second capacitor C2 is similar to the capacitance value of the first capacitor C1, the energy from the power input will be stored separately in the semi-resonance circuit constituted by the first capacitor C1, the second inductor L2 and the second capacitor C2. As the across voltage of the capacitor C1 arises quickly, the stored energy of the first capacitor C1 is converted into the inductor current i_{L2} via the resonance of the second inductor L2 and the first capacitor C1. Meanwhile the polarity of the across voltage of the first capacitor C1 is inversed. The input energy is conveyed to the second capacitor C2 through the resonance effect in cooperation with the first inductor L1. After further enhancing the upper cross voltage of the second capacitor C2, the energy is conveyed to the double-voltage circuit via the transformer. When an upper reverse cross voltage of the first capacitor C1 is greater than the sum of the cross voltages of the second capacitor C2 and the first inductor L1, the soft switching technique is realized and the circuit configuration of the converter is changed after a flywheel diode of an open-circuit active switching element is turned on. When the input terminal is of the full bridge circuit architecture, the principle of operation for the circuit of the present invention is similar to the principle described above, except that the output voltage is twice the above-described circuit. In FIG. 1B, the circuit at the secondary side of the transformer is a double-voltage rectifier circuit for the purpose of exemplification, but it does not intend to limit the circuit of the invention to this example. Other rectifier circuits as shown in the series of FIG. 1 and FIG. 2 can be used as well.

The circuit of the invention can control the operation mode of the circuit by adjusting the circuit parameters. The following description is based on the half-bridge resonant DC converter circuit of FIG. 1B at the boost-mode. In this embodiment, in order that the circuit of the invention can work at the best operation mode, only two inductors L1, L2, operating in a manner of continuously conducting the current, are taken as example for illustration. In order to clearly illustrate how the half-bridge resonant DC converter circuit of the present invention works, it is assumed that all the circuit elements are ideal, and each of their loads is pure resistance R. The working modes of the half-bridge resonant DC converter circuit are described as follows.

### [Working Mode 1]

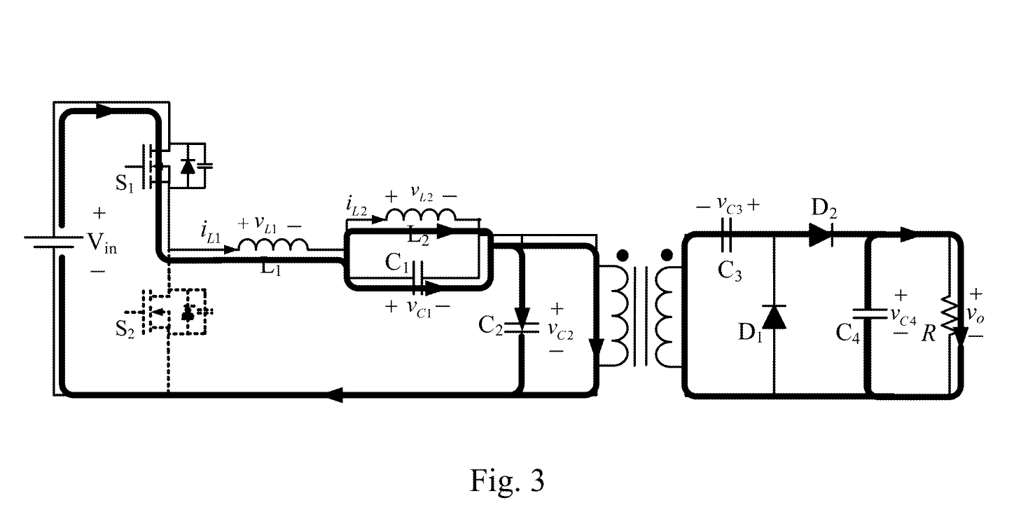

Refer to FIG. 3 which is a schematic diagram of an equivalent circuit of a resonant DC converter in the Working Mode 1 according to the present invention. As shown, when the first active switching element S1 is turned on while the second active switching element S2 is turned off, the energy storage inductor L1 is charged by the input power supply Vᵢₙ via the first active switching elements S1, while the energy is conveyed to the second capacitor C2 after passing through the L2C1 resonant circuit. Then, through the transformer and the second diode D2, the third capacitor C3 and the fourth capacitor C4 are charged and the energy is provided to the load. Its equivalent circuit is as shown in FIG. 3. When the first active switching element S1 is turned off and the flywheel diode of the second active switching element S2 is turned on, the circuit of the present invention goes to the Working Model 2.

[Working Mode 2]

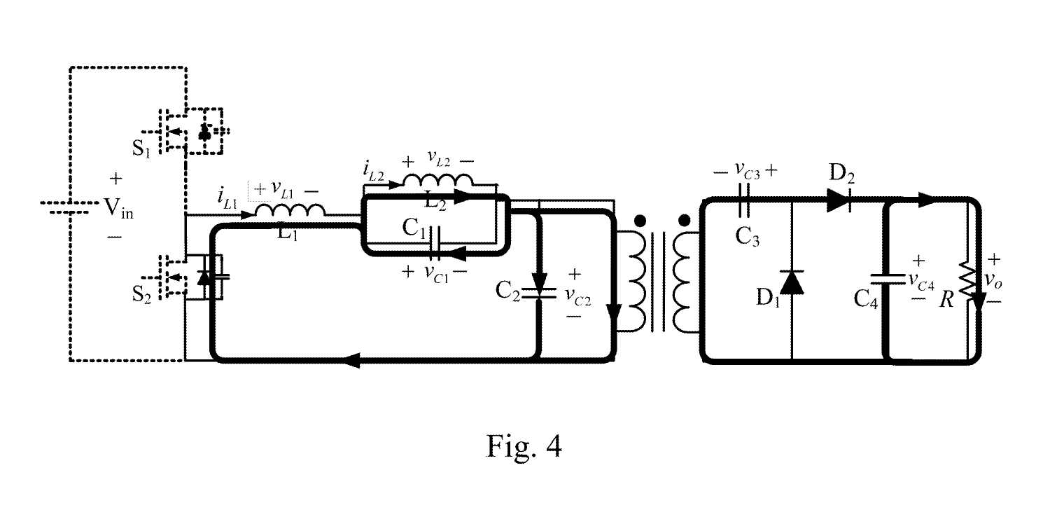

Refer to FIG. 4 which is a schematic diagram of an equivalent circuit of a resonant DC converter in the Working Mode 2 according to the present invention. As shown, when the first active switching element S1 and the second active switching element S2 are simultaneously turned off, the second inductor L2 and the first capacitor C1 are in resonance. The stored energy of the first capacitor C1 is converted into inductor current i_{L2}. The polarity of the across voltage of the first capacitor C1 is inverted. The flywheel diode of the second active switching element S2 is turned on to change the circuit architecture. The first inductor L1, the second capacitor C2, the L2C1 resonant circuit and the flywheel diodes circuit of the second active switching element S2 constitute a loop. With the use of the transformer, the stored energy is conveyed to the secondary side thereof. The third capacitor C3 is charged via the second diode D2. The fourth capacitor C4 continues providing the energy to the load. Its equivalent circuit is shown in FIG. 4. When the second active switching element S2 is turned on, the circuit of the present invention goes into the Working Mode 3.

[Working Mode 3]

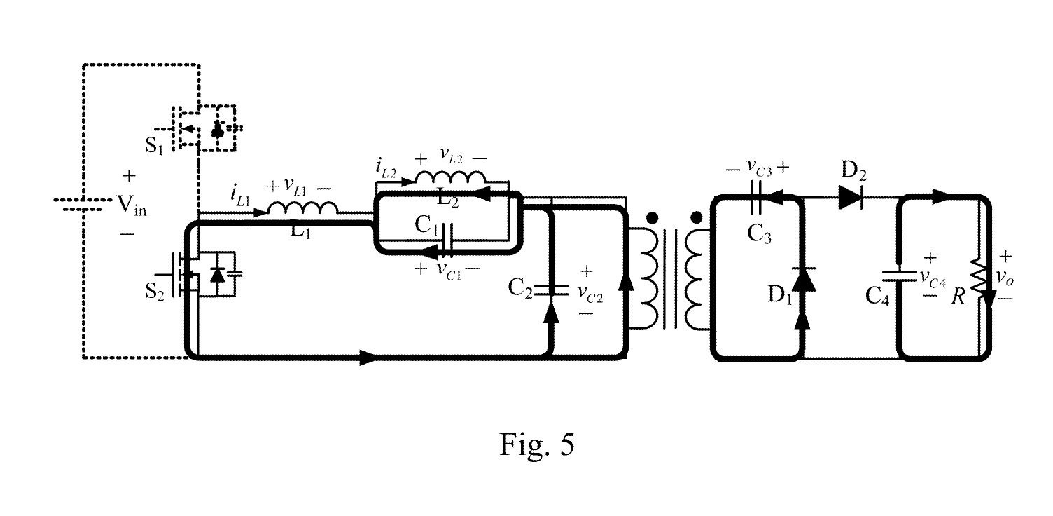

Refer to FIG. 5 which is a schematic diagram of an equivalent circuit of a resonant DC converter in the Working Mode 3 according to the present invention. As shown, when the first active switching element S1 is turned off while the second active switching element S2 is turned on, the third capacitor C3 is charged by the first inductor L1, the second capacitor C2 and the L2C1 resonant circuit via the transformer and the first diode D1. Meanwhile, the fourth capacitor C4 provides the energy to the load. Its equivalent circuit is as shown in FIG. 5. When the second active switching device S2 is turned off, and the flywheel diode of the first active switching elements S1 is turned on, the circuit of the present invention goes into the Working Mode 4.

[Work Mode 4]

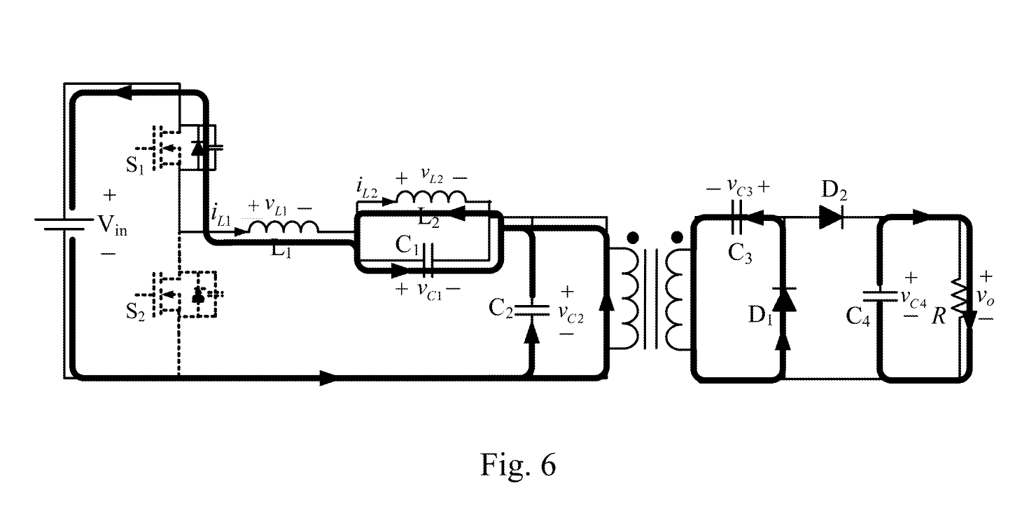

Refer to FIG. 6 which is a schematic diagram of an equivalent circuit of a resonant DC converter in the Working Mode 4 according to the present invention. As shown, when the first active switching element S1 and the second active switching element S2 are simultaneously turned off, the second inductor L2 and the first capacitor C1 are in resonance. The stored energy of the first capacitor C1 is converted into inductor current i_{L2}. The polarity of the across voltage of the first capacitor C1 is inverted. The flywheel diode of the second active switching element S2 is turned on to change the circuit architecture. The first inductor L1, the second capacitor C2, the L2C1 resonant circuit and the flywheel diodes circuit of the second active switching element S2 constitute a loop. With the use of the transformer, the stored energy is conveyed to the secondary side. The third capacitor C3 is charged through the first diode D1. The fourth capacitor C4 provides the energy to the load. Its equivalent circuit is shown in FIG. 6. When the first active switching element S1 is turned on, the circuit of the present invention goes into the Working Mode 1. Thereby, it finishes the action for one cycle.

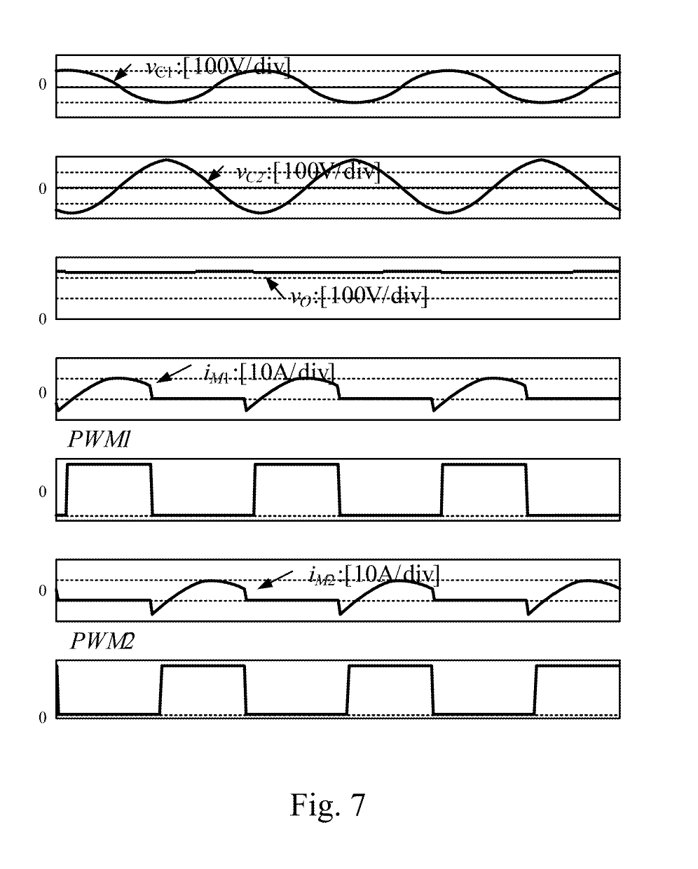

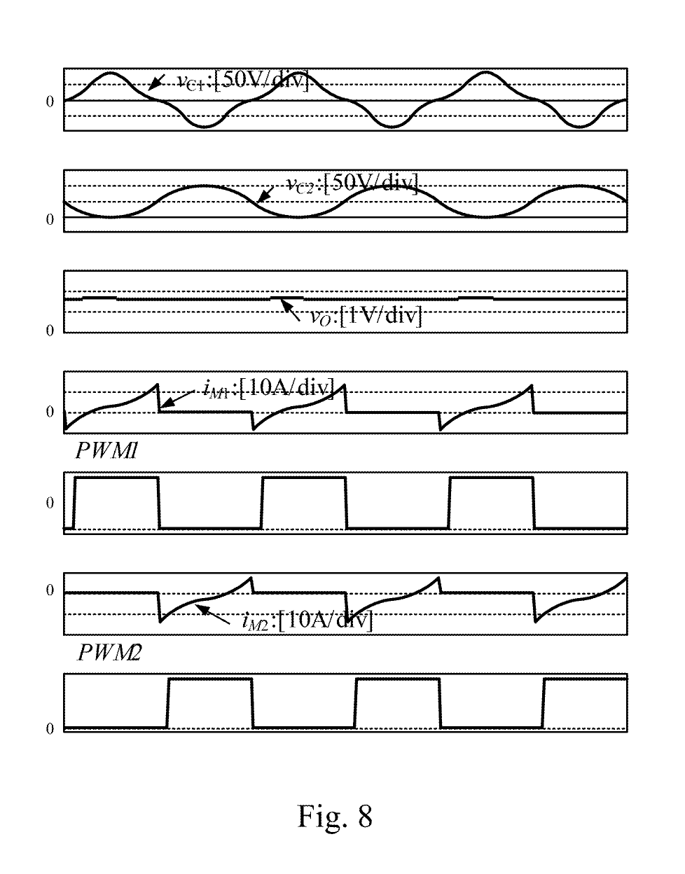

FIG. 7 is a schematic diagram of a simulated waveform 1 for V_{C1}, V_{C2}, V_{O}, I_{M1}, I_{M2}, PWM1 and PWM2 signals of a resonant DC converter according to the present invention. FIG. 8 is a schematic diagram of a simulated waveform 2 for V_{C1}, V_{C2}, V_{O}, I_{M1}, I_{M2}, PWM1 and PWM2 signals of a resonant DC converter according to the invention. As shown, in order to verify the practicability and progress of the resonant DC converter according to the present invention, the converter circuit is in simulation at boost and buck modes by circuit simulation software. The circuit parameters are respectively shown in Table I and Table II. Table I shows parameters of the circuit at boost mode. Table II shows parameters of the circuit at buck mode. V_{C1} and V_{C2}. The simulation results shown in FIG. 7 and FIG. 8 are respectively the capacitor voltages of the first capacitor C1 and the second capacitor C2 in the circuit of the present invention. i_{M1}˜i_{M2} are respectively currents of the first active switching element S1 and the second active the switching element S2 in the circuit of the present invention. PWM1 and PWM2 are respectively control signals of the first active switching element S1 and the second active switching element S2 in the circuit of the present invention. V_{C1} is an output voltage of the circuit of the present invention.

TABLE I

| | Values | |
|---|---|---|
| L1 | 10 | uH |
| L2 | 10 | uH |
| Lm | 0.5 | mH |
| C1 | 0.1 | uF |
| C2 | 0.1 | uF |
| C3, C4 | 1 | uF |
| Duty cycle | 0.5 | |
| Input voltage | 12 | V |
| Switching frequency | 100 | KHz |
| load resistance | 2000 | Ω |

TABLE II

| | Values | |
|---|---|---|
| L1 | 10 | uH |
| L2 | 10 | uH |
| Lm | 0.5 | mH |
| C1 | 0.1 | uF |
| C2 | 0.22 | uF |
| C3, C4 | 10 | uF |
| Duty cycle | 0.5 | |
| Input voltage | 100 | V |
| Switching frequency | 100 | KHz |
| load resistance | 20 | Ω |

From the simulation results of FIG. 7, it is found that the resonant DC converter shown in FIG. 1B operates at boost mode at input voltage of 12V and output voltage of 229.25V, with step-up ratio of 19.10 and output voltage ripple of 0.75. In addition, from the simulation results of FIG. 7, it can also be found that the resonant DC converter of the present invention achieves the effect of soft switching for all the switching elements. Furthermore, from the simulation results of FIG. 8, it can be found that the resonant DC converter shown in FIG. 1B operates at buck mode, at input voltage of 100V, output voltage of 2.71V, step-down ratio of 36.9, and output voltage ripple of 0.068. From the simulation results of FIG. 8, it can be also found that the resonant DC converter of the present invention achieves the soft switching for all the switching elements.

Thereby, the resonant DC converter circuit of the present invention can improve the power density of the converter and reduce the costs by means of increasing the switching frequency and reducing the volume of magnetic components. In cooperation with the full-bridge or half-bridge resonant DC conversion circuit according to the invention, the integrated transformer, the double-voltage rectifier circuit and the voltage type auto charge pump circuit can partially separate the inductance of the first inductor L1 of the resonant element in the circuit as the resonant inductor L2, and constitute the L2C1 resonant circuit by coupling the second inductor L2 with the first capacitor C1 in parallel. The circuit architectures are shown in FIG. 1A through FIG. 1G and FIG. 2A through FIG. 2G. In addition, by means of the design of parameters and action of the LC resonant circuit, the circuit is made to have characteristics of variable circuit architecture. With the cooperation with the second capacitor C2, an in-series resonant in-parallel load circuit is constituted to achieve the effect of high voltage conversion ratio. The conversion ratio of the output voltage can be further improved by means of the double-voltage rectifier circuit at the secondary side of the transformer. Furthermore, by means of integration of the LC resonant circuit with the active switching elements, it can realize the soft switching technique to reduce any switching loss and electric magnetic interruption (EMI). Compared to the conventional circuit in terms of functions, means and effect, the integration of the switching elements for the DC converter circuit, and the characteristics of automatically changing the circuit architecture of the voltage type auto charge pump circuit according to the present invention contribute to achieve the effect of soft switching, low output voltage ripple and high voltage conversion ratio so as to achieve high power density, high voltage conversion ratio, low cost, low EMI, low output voltage ripple, long service life and high conversion efficiency.

In summary, the present invention relates to a resonant DC converter which has integrated soft-switching technology with high voltage conversion and can effectively improve the shortcomings of conventional technology. This invention integrates the transformer, the double-voltage rectifier circuit and the voltage type auto charge pump circuit with the full-bridge or half-bridge resonant DC conversion circuit. The design of circuit parameters and the action of the LC resonant circuit make the circuit have the characteristics of variable circuit architecture, and achieve the effect of soft switching, low output voltage ripple and high voltage conversion ratio. It helps to avoid using large-capacitance electrolytic capacitors and be able to extend the service life of the transformer, so as to achieve high power density, high voltage conversion ratio, low costs, low electric magnetic interruption (EMI), low output voltage ripple, long service life and high conversion efficiency. The operation of the circuit of the invention at boost or buck mode can be controlled by adjusting the circuit parameters. This makes the invention more progressive and more practical in use which complies with the patent law.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A resonant DC converter, used to convert a DC input voltage into a DC output voltage in order to provide a load with power supply, comprising:
a front-end conversion circuit, comprising a half-bridge resonant DC conversion circuit and a voltage-type auto charge pump circuit, wherein the half-bridge resonant conversion circuit is provided with a positive voltage terminal and a negative voltage terminal at an input side respectively connecting a first active switching element and a second active switching element to a positive voltage terminal of a first inductor, the positive voltage terminal of the first inductor is coupled to one common node between the first active switching element and the second active switching element, a negative voltage terminal of the first inductor; is coupled in series to a semi-resonant circuit of the voltage-type auto charge pump circuit, the semi-resonant circuit contains a second inductor and a first capacitor coupled with the second inductor in parallel, and the voltage-type auto charge pump circuit further includes a second capacitor coupled in series to the semi-resonant circuit; and
a transformer, wherein a primary side of the transformer is coupled to the front-end conversion circuit and to the second capacitor in parallel, a secondary side of the transformer is coupled to a rear-end conversion circuit which is electrically coupled with the front-end conversion circuit through the transformer.

2. The resonant DC converter of claim 1, wherein the secondary side of the transformer is coupled with the rear-end conversion circuit which is a full-bridge rectifier circuit constituted by four diodes and a capacitor.

3. The resonant DC converter of claim 1, wherein the secondary side of the transformer is coupled with the rear-end conversion circuit which is a double-voltage rectifier circuit constituted by two diodes and two capacitors.

4. The resonant DC converter of claim 1, wherein the transformer is a multi-winding transformer, and the secondary side of the transformer is coupled with the rear-end conversion circuit which is a rectifier circuit constituted by two diodes and one capacitor.

5. The resonant DC converter of claim 1, wherein the transformer is a multi-winding transformer, and the secondary side of the transformer is coupled with the rear-end conversion circuit which is a triple-voltage rectifier circuit constituted by four diodes and three capacitors.

6. The resonant DC converter of claim 1, wherein the transformer is a multi-winding transformer, and the secondary side of the transformer is coupled with the rear-end conversion circuit which is a four times-voltage rectifier circuit constituted by four diodes and four capacitors.

7. The resonant DC converter of claim 1, wherein the transformer is a multi-winding transformer, and the secondary side of the transformer is coupled with the rear-end conversion circuit which is a five times-voltage rectifier circuit constituted by six diodes and five capacitors.

8. The resonant DC converter of claim 1, wherein the transformer is a multi-winding transformer, and the secondary side of the transformer is coupled with the rear-end conversion circuit which is a six times-voltage rectifier circuit constituted by six diodes and six capacitors.

9. A resonant DC converter, used to convert a DC input voltage into a DC output voltage in order to provide a load with power supply, comprising:
a front-end conversion circuit, comprising a full-bridge resonant DC conversion circuit and a voltage-type auto charge pump circuit, wherein the full-bridge resonant conversion circuit is provided with a positive voltage terminal at an input side in coupling with a first active switching element and a second active switching element in parallel, and a negative voltage terminal at the input side in coupling with a third active switching element and a fourth active switching element in parallel, the first active switching element and the third active switching element are coupled in series with a positive voltage terminal of a first inductor, the positive voltage terminal of the first inductor is coupled with one common node between the first active switching element and the third active switching element, a negative voltage terminal of the first inductor is coupled in series to a semi-resonant circuit of the voltage-type auto charge pump circuit, the semi-resonant circuit contains a second inductor and a capacitor coupled with the second inductor in parallel, the voltage-type auto charge pump circuit further includes a second capacitor coupled in series with the semi-resonant circuit, and the second capacitor is coupled with one common node between the second active switching element and the fourth active switching element; and
a transformer, wherein a primary side of the transformer is coupled to the front-end conversion circuit and to the second capacitor in parallel, a secondary side of the transformer is coupled to a rear-end conversion circuit which is electrically coupled with the front-end conversion circuit through the transformer.

10. The resonant DC converter of claim 9, wherein the secondary side of the transformer is coupled with the rear-end conversion circuit which is a full-bridge rectifier circuit constituted by four diodes and a capacitor.

11. The resonant DC converter of claim 9, wherein the secondary side of the transformer is coupled with the rear-end conversion circuit which is a double-voltage rectifier circuit constituted by two diodes and two capacitors.

12. The resonant DC converter of claim 9, wherein the transformer is a multi-winding transformer, and the secondary side of the transformer is coupled with the rear-end conversion circuit which is a rectifier circuit constituted by two diodes and one capacitor.

13. The resonant DC converter of claim 9, wherein the transformer is a multi-winding transformer, and the secondary side of the transformer is coupled with the rear-end conversion circuit which is a triple-voltage rectifier circuit constituted by four diodes and three capacitors.

14. The resonant DC converter of claim 9, wherein the transformer is a multi-winding transformer, and the secondary side of the transformer is coupled with the rear-end conversion circuit which is a four times-voltage rectifier circuit constituted by four diodes and four capacitors.

15. The resonant DC converter of claim 9, wherein the transformer is a multi-winding transformer, and the secondary side of the transformer is coupled with the rear-end conversion circuit which is a five times-voltage rectifier circuit constituted by six diodes and five capacitors.

16. The resonant DC converter of claim 9, wherein the transformer is a multi-winding transformer, and the secondary side of the transformer is coupled with the rear-end conversion circuit which is a six times-voltage rectifier circuit constituted by six diodes and six capacitor.
